(19) United States
(12) Patent Application Publication
(10) Pub. No.: US 2011/0188690 A1
(43) Pub. Date: Aug. 4, 2011

(54) RECEIVER IN CONCHA

(75) Inventors: Tina Ahlberg LARSEN, Birkerod (DK); Lars Baekgaard JENSEN, Farum (DK); Morten Agerbaek NORDAHN, Bronshoj (DK)

(73) Assignee: WIDEX A/S, Lynge (DK)

(21) Appl. No.: 13/083,048

(22) Filed: Apr. 8, 2011

Related U.S. Application Data
(63) Continuation-in-part of application No. PCT/DK2008/000357, filed on Oct. 10, 2008.

(51) Int. Cl. H04R 25/00

(52) U.S. Cl. 381/328

(57) ABSTRACT

An elastic sleeve member (1) for a receiver module of a hearing aid of the receiver-in-the-ear (RITE) type comprises an elongated housing adapted for receiving an electrical input signal from said hearing aid, a sound output port and at least one receiver for converting said input signal to an acoustic output signal. The sleeve member (1) comprises a body (2) adapted to at least partly enclose said receiver module, and a spout (3) for extending said sound output port of the elongated housing into the ear. The invention further provides a receiver assembly and a hearing aid.

### RELATED APPLICATIONS

The present application is a continuation-in-part of application No. PCT/DK2008000357, filed on Oct. 10, 2008, in Denmark and published as WO2010040351 A1.

### BACKGROUND OF THE INVENTION

1. Field of the Invention

The present invention relates to hearing aids. The invention, more specifically, relates to a sleeve member for a receiver module of a hearing aid of the receiver-in-the-ear (RITE) type.

The small anatomy of children and their fast growth and development puts some constraints on the design of hearing aids for children. Due to space limitations hearing aids for children are typically of the behind-the-ear (BTE) types with an ear mould that guides a compensated acoustic signal into the ear. An ear mould must fit correctly into an ear in order to guide the acoustic signal into the ear and to make it comfortable to wear. Due to children's fast growth it is difficult to provide an ear mould that fits correctly. An ear mould is made from an imprint of the ear, which typically is made by a fitter.

Since the ear of the child grows quite fast, a new mould is normally made a little bit too big, so as to fit the ear for a longer period, since it is a costly and time consuming process to consult a fitter and produce a new mould. The traditional process of making an ear mould with a perfect fit is thus not suitable for hearing aids for children. Consequently, the hearing impaired child almost never experiences an ear mould and a hearing aid that fits and functions perfectly. Furthermore, the acoustic guiding tube from the hearing aid to the ear mould is disturbing for a child's perception of sounds because even a light touch on the tube will be experienced as noise in the ear. This is particularly a problem when the child sleeps on the side or plays around, since it has an influence on the child's well being.

The limited space for the hearing aid, and thereby the corresponding limited space for components therein, has a direct impact on the properties of a hearing aid.

2. Prior Art

It is well known to move the receiver from behind the ear to the ear canal in order to save space behind the ear, but according to the article “Ear-Canal impedance and reflection coefficient in human infants and adults” by Keefe et al., published in Journal of the Acoustical Society of America, Vol. 94, No. 5, November 1993, the ear canal of infants and children up to three years is too small to contain a receiver used in typical hearing aid designs for children.

WO-A1-2008095505 provides a hearing aid systems of the Receiver-In-The-Ear (RITE) type. This type of hearing aid generally comprises a housing for placement behind the pinna of a user and an ear canal module for placement in the concha or the auditory meatus of the user. The housing, sometimes referred to as a BTE-housing, is shaped to match the pinna and generally accommodates microphone, processor and battery. The ear canal module, sometimes referred to as a RITE-module is shaped to match the auditory meatus and accommodates the receiver (i.e. a miniature speaker).

Matching of the BTE-housing and of the ear canal module to the user may be by providing shapes to match an average of users, by providing a selection of shapes among which the user may choose, or it may be by customizing the shape to the specific user. An additional measure to obtain a comfortable fit is the selection of pliant and conformable materials for the components. Customizing may be by making an impression and casting or by somehow retrieving the contours of the user and making a component by a computerized, additive process such as an SLA method. These methods are all in use in the field.

RITE hearing aids are distinguished from traditional BTE hearing aids, where the receiver is located in the BTE housing component. In BTE hearing aids sound emitted from the receiver in the BTE housing component is conducted to the ear canal, e.g. to an earplug located there, by a sound conducting tube.

WO-A1-2007022773 provides a hearing aid having two independently driven acoustic output transducers for reproducing low-frequency and high frequency bands in the audible spectrum.

Hearing aids of the RITE type have the receiver located in the ear canal of the user, or at least in the vicinity thereof, thereby avoiding the sound tube and its influence on the sound emitted by the receiver, e.g. attenuating of certain frequencies.

The receiver, which converts an amplified electric signal to an acoustic output signal, is determining for the output frequency range of a hearing aid. In both a receiver-in-the-ear design and a receiver-behind-the-ear design for children, the output frequency range of the hearing aid will be limited, because of the limited space for the receiver, leaving room for only a single receiver. This limits the possible operating frequency range, because the frequency range has to be covered by the single receiver rather than by two receivers in conjunction covering a broader range. Typically, the operating frequency range is limited to only 6 kHz for hearing aids for children, which is far less than the frequency range audible to the acoustically unimpaired.

Studies have shown that sounds up to 10 kHz are important for a child to develop a language. Hence the limited operating frequency range of a hearing aid for children has an impact on the language learning and general well being of a child with a hearing loss.

### SUMMARY OF THE INVENTION

On the basis on the above-mentioned problems, it is a feature of the present invention to provide a hearing aid with an improved operating frequency range that is easy to fit into the ear of a child.

The invention, in a first aspect, provides a sleeve member made of an elastic material adapted for mounting a receiver module of a hearing aid of the receiver-in-the-ear (RITE) type in the concha of the ear, wherein said receiver module comprising an elongated housing having an elongation in a first direction and adapted for receiving an electrical input signal from said hearing aid, a sound output port and at least one receiver for converting said input signal to an acoustic output signal, said sleeve member comprising a body adapted to at least partly enclose said receiver module when inserted therein, and a spout for extending said sound output port of the housing into the ear, wherein the spout extends said output port towards a direction differing from said first direction.

Using such a sleeve allows the receiver module to be placed and held in the concha of the ear where there is better room than in the ear canal. At the same time there is no longer a need for an acoustic tube guiding sound from the hearing aid to the ear, whereby noise originating from touching the tube is eliminated and the resonance of the receiver is limited to the resonance of the ear canal, which simplifies modelling of the acoustics of the hearing aid and thus simplifies the fitting. Designing the hearing aid with the receiver in to the ear, allows more space to be provided for components in the receiver module and thereby enabling the use of more than one receiver, which provides a broader frequency range of the output signal, as a combination of receivers can be used for covering an extended part of the frequency spectrum. The use of a sleeve with a spout makes it easy to fit the receiver module into the ear, and furthermore imprints of the ear are rendered superfluous. Moreover, by placing the receiver module in the ear the part of the hearing aid behind the ear can be made smaller and thereby more comfortable to wear.

In a specific embodiment of the invention, the receiver module is made even more comfortable to wear and easier to fit correctly into the ear because said spout is tubular and adapted to fit into an ear canal.

In a further embodiment of the invention, the sleeve member of the receiver module is replaceable. Hereby it is possible to replace the sleeve member with a new one having a larger spout better suited to correctly fit the child's ear as the child grows, because the sleeve can be replaced as soon as a larger spout fits better into the ear canal. Furthermore, sleeve members are much cheaper to produce than imprints, and there is no need to visit a fitter in order to fit the hearing aid to the child's ear as it grows. This is especially an advantage in areas where it is difficult to visit a fitter or where a fitter is not available.

In another embodiment, the sleeve member comprises a soft silicone material, which makes it comfortable to wear and makes the spout of the sleeve member flexible to fit into the ear. Moreover the silicone material is biocompatible.

In a further embodiment of the invention, the body of the sleeve member is adapted to enclose a receiver module to be mounted in the concha of the ear. This provides a good fit of the receiver module in the ear and still leaves room for more than one receiver and provides a good connection of the spout of the sleeve member into the ear canal.

The invention, in a second aspect, provides a receiver assembly adapted for mounting a hearing aid of the receiver-in-the-ear (RITE) type in the concha of the ear, wherein said receiver assembly comprises a receiver module adapted for receiving an electrical input signal from said hearing aid, and comprising at least one receiver for converting said input signal to an acoustic output signal, said receiver module further comprising an elongated housing having an elongation in a first direction and a sound output port, and a sleeve member made of an elastic material comprising a body adapted to at least partly enclose said receiver module when inserted therein, and a spout for extending said sound output port of the elongated housing into the ear, wherein said spout is adapted to extend said output port towards a second direction differing from said first direction.

In another embodiment of the second aspect of the invention, the receiver assembly is made even more comfortable to wear and easier to fit correctly into the ear because said spout is tubular and adapted to fit into an ear canal.

In a further embodiment of the second aspect of the invention, the sleeve member of the receiver assembly is replaceable. Hereby it is possible to replace the sleeve member of the receiver assembly with a new one having a larger spout, suitable to correctly fit the child's ear as the child grows, because the sleeve member of the receiver assembly can be replaced as soon as a larger spout would fit better into the ear canal. Furthermore, standardized sleeve members are much cheaper to produce than ear moulds corresponding to individual imprints and there is no need to visit a fitter in order to fit the hearing aid to the child's ear as it grows. This is especially an advantage in areas where it is difficult to visit a fitter or when a fitter is not available.

In another embodiment of the second aspect of the invention, the sleeve member of the receiver assembly comprises a soft silicone material, which makes it comfortable to wear and makes the spout of the sleeve member flexible to fit into the ear. Moreover the silicone material is biocompatible.

In another embodiment of the second aspect of the invention, the receiver assembly comprises a socket for receiving a plug for conducting an electrical input signal, and said housing has a symmetry plane in which said socket is disposed. This makes the receiver module suitable for both left and right ears, which is an advantage in relation to the production of receiver modules according to the invention. Having the socket placed on a symmetry plane is to be understood as the socket having at least one point in common with a plane dividing the receiver module into two symmetric elements.

The invention, in a third aspect, provides a hearing aid of the receiver-in-the-ear (RITE) type comprising a receiver module to be mounted in a concha of the ear and adapted for receiving an electrical input signal, said receiver module comprising at least one receiver for converting said input signal to an acoustic output signal, said receiver module further comprising an elongated housing having an elongation in a first direction, and a sleeve member made of an elastic material and comprising a body adapted to at least partly enclose said receiver module when inserted therein, and a spout for extending said sound output port of the elongated housing into the ear, wherein said spout extends said output port towards a second direction differing from said first direction.

This provides a good fit of the receiver module while leaving room for more than one receiver and providing a good connection of the spout of the sleeve member into the ear canal. Furthermore, the BTE housing can be made smaller when it does not need to accommodate the receiver part.

In an embodiment of the third aspect of the invention, the receiver module is adapted to be mounted in an ear mould. This makes it possible to use the hearing aid in conjunction with existing ear mould imprints, which still is an advantage because a better frequency range of the sound output signal is provided.

### BRIEF DESCRIPTION OF THE DRAWINGS

In the following, the invention will be described in further detail by means of examples of embodiments with reference to the schematic drawings, in which

FIG. 1 is a perspective view of a first embodiment of a sleeve member according to the present invention;

FIG. 2 is a perspective view of a first embodiment of a receiver module according to the present invention;

FIG. 3 is a perspective view of the receiver module of FIG. 2 enclosed by the sleeve member of FIG. 1 to form a receiver assembly;

FIG. 4 is an exploded view of the receiver module of FIG. 1;

FIG. 5 is a perspective view of a second embodiment of a sleeve member according to the present invention;

FIG. 6 is a cross-sectional view of the sleeve member of FIG. 5;

FIG. 7 is an exploded view of a second embodiment of a receiver module according to the invention and adapted to the sleeve member of FIG. 5; and

FIG. 8 shows a hearing aid connected to a receiver assembly according to an embodiment of the invention.

### DETAILED DESCRIPTION OF THE INVENTION

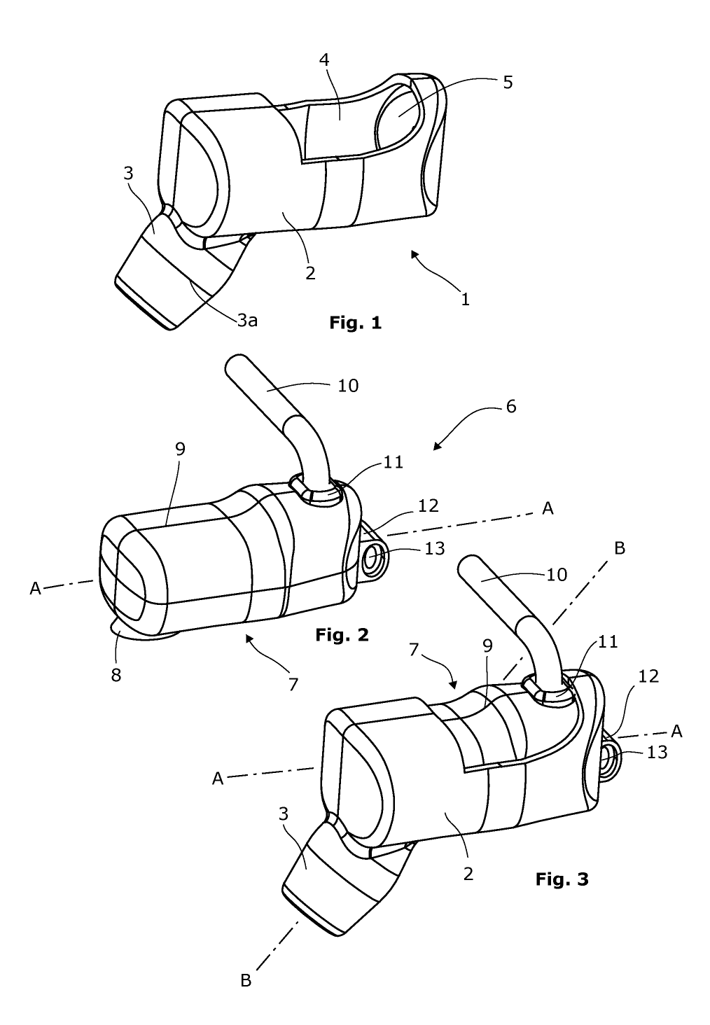

In FIG. 1 is shown a first embodiment of a sleeve member 1 comprising a body 2 and a tubular spout 3 according to an embodiment of the invention. The body 2 is adapted to enclose a receiver module 6 as illustrated in FIG. 2 and has a first opening 4, a second opening 5 and a third opening (not shown) from which the spout 3 extends. The wall thickness of the tubular spout 3 varies, so that the tubular spout 3 has a larger diameter at the drawn line 3a, which makes the spout 3 bi-conic. In one embodiment the spout is circular, whereas, in other embodiments the spout is oval for better fit. This provides a good fit of the spout 3 into an ear canal as well as a flexible joint between the spout 3 and the body 2 of the sleeve member 1, which makes it easier to position the receiver module correctly into the ear. In order to fit properly into ear canals of different sizes, sleeve members 1 can be made with spouts 3 of different diameters or different shapes in order to provide a selection to give more options for finding a good fit into the ear. For infants and small children a sleeve member 1 with a spout 3 having an outer diameter at the line 3a from 3 mm to 9.5 mm is preferred. The entire sleeve member 1 is preferably made of one and the same material, e.g. a soft, biocompatible and elastic material, which adapts to the shape of the ear canal of the user. One preferred material is silicone rubber, but the skilled person will realise that other materials could be used eg. a fluorosilicone or a thermoplastic elastomer. Elastic in this context means that the material has a Shore A hardness of less than 90, and soft elastic material means that the material has a Shore A hardness less than 50, e.g. in the interval of 15 to 40, preferably 25.

FIG. 2 illustrates a first embodiment of a receiver module 6 according to the invention, the receiver module 6 comprising an elongated housing 7 having an elongation in a first direction indicated with the broken line A-A, and a second spout 8 extending from a sound output port (not shown) of the elongated housing 7. The elongated housing 7 has a symmetry plane illustrated by the line 9 in which an electrical input wire 10 with a plug 11 is fixed in a socket (not shown) positioned in said symmetry plane 9 at the opposite end of the elongated housing 7 with respect to the second spout 8. The elongated housing 7 has a protrusion 12 with a bore 13 for fastening means for fixing the receiver module 6 to the ear. The second spout 8 serves as a sound conductor in connection with the spout 3 of the sleeve member 1 of FIG. 1 as will be explained later. It is obvious that the elongated housing 7 and the second spout 8 can take many forms. This makes it possible to use the receiver module 6 without the sleeve member 1 in connection with a traditional earplug and still achieve some of the advantages of the invention. It is obvious that the integration of a traditional earplug made by a computerized, additive process, such as CAMISHA®, and the receiver module 6 according to the invention can be designed in many ways such as by providing a snap connection between the two parts.

Furthermore, experiments have shown that the best way of utilizing the space in the ear and providing the smallest possible height of the receiver module 6 and a good fit in the concha of the ear is by positioning the socket in said symmetry plane 9 in the opposite end of the receiver module 6 according to the second spout 8 as described above. The height of the receiver module 6 is crucial for fitting the receiver module 6 into the concha of the ear and still making the receiver module 6 comfortable to wear.

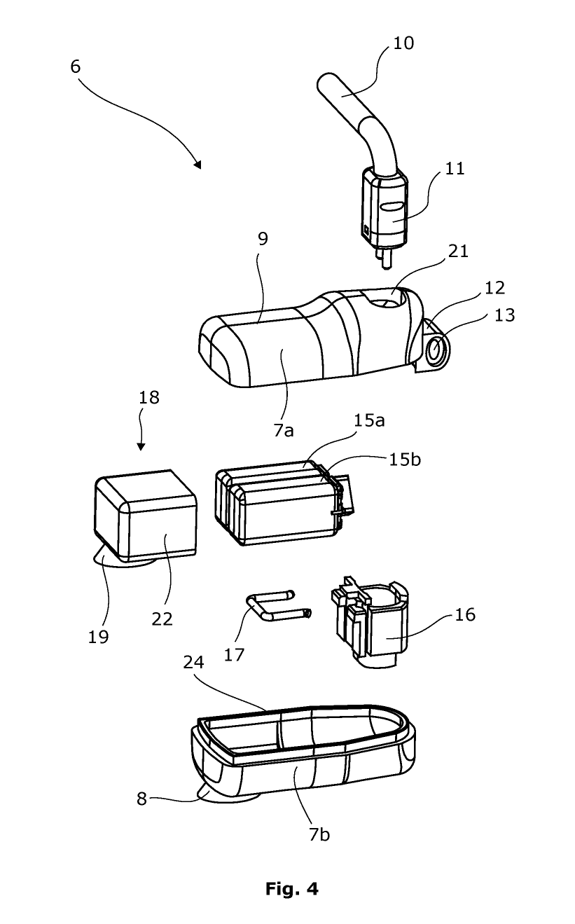

FIG. 3 illustrates the receiver assembly according to the second aspect of the invention, i.e. a receiver module 6 enclosed by the body 2 of the sleeve member 1 according to the first aspect of the invention. The first opening 4 of the sleeve member 1 serves as an opening for insertion of the receiver module 6 into the sleeve member 1. The material chosen for the sleeve member 1 and the shape of the opening 4 facilitate this insertion. Besides from being used for mounting the receiver module 6 inside the body 2 of the sleeve member 1, the first opening 4 provides an opening for a plug 11 of the electrical input wire 10 to the socket of the elongated housing 7. As shown in FIG. 3, the second opening of the sleeve member 1 provides an opening for the protrusion 12. The body 2 encloses the receiver module 6 and the spout 8 like a hose.

Also, in FIG. 3 it is best seen that when the elongated housing 7 of the receiver module 6 is inserted in the sleeve member 1, the sound output port of the entire assembly is directed towards a second direction illustrated by the broken line B-B, different from the direction of the elongation of the elongated housing 7 of the receiver module. The sound is thus directed into the ear canal, while at the same time the receiver module lies in the concha, and the height of the assembly protruding out of the concha is kept to a minimum.

FIG. 4 is an exploded view of the receiver module 6. An upper part 7a and a lower part 7b comprise the elongated housing 7. The upper part 7a has an opening 21 positioned in the symmetry plane illustrated by the line 9 for receiving the plug 11 of the electrical input wire 10. In the embodiment shown, the receiver module 6 comprises two receivers 15a, 15b, a socket element 16 for receiving the plug 11, a fastening spring 17 for fixing the plug 11 to the socket element 16 and a damping member 18 comprising a second body 22 and a third spout 19 adapted to fit into to the second spout 8 of the lower part 7b of the elongated housing 7. The damping member 18 is adapted to enclose one end of the receivers 15a, 15b and thereby forming a sound conduit (not shown) from the outputs of the receivers 15a, 15b. The damping body 18 guides the sound output from the receivers 15a, 15b into the spout 8 of the lower part 7b and furthermore has a damping purpose against vibrations and sounds propagating in the housing. The damping body 18 is preferably made of rubber or a material with similar capabilities with respect to sound guidance and damping.

As shown in FIG. 4 the lower part 7b of the elongated housing 7 of the receiver module 6 has an edge 24 adapted to fit into a corresponding recess (not shown) of the upper part 7a. The two parts 7a, 7b can be glued or welded together, or the edge 24 or the recess can be designed so as to provide a snap interlock between the upper part 7a and the lower part 7b, which makes it possible to click the two parts together, and provides for easy disassembly. Laser welding or ultrasonic welding are suitable welding methods.

The components inside the elongated housing 7 of the receiver module 6 and especially the receivers 15a, 15a are sensitive to dirt and in particular ear wax, and therefore the receiver module 6 is typically provided with an ear wax guard or a similar arrangement in connection with the output port of the housing, preferably in connection with the spout 8 of the housing 7, to prevent dirt from penetrating into the housing 7. The ear wax guard is not visible in FIGS. 1-4, but will be described further below in conjunction with a second, currently preferred, embodiment of the invention.

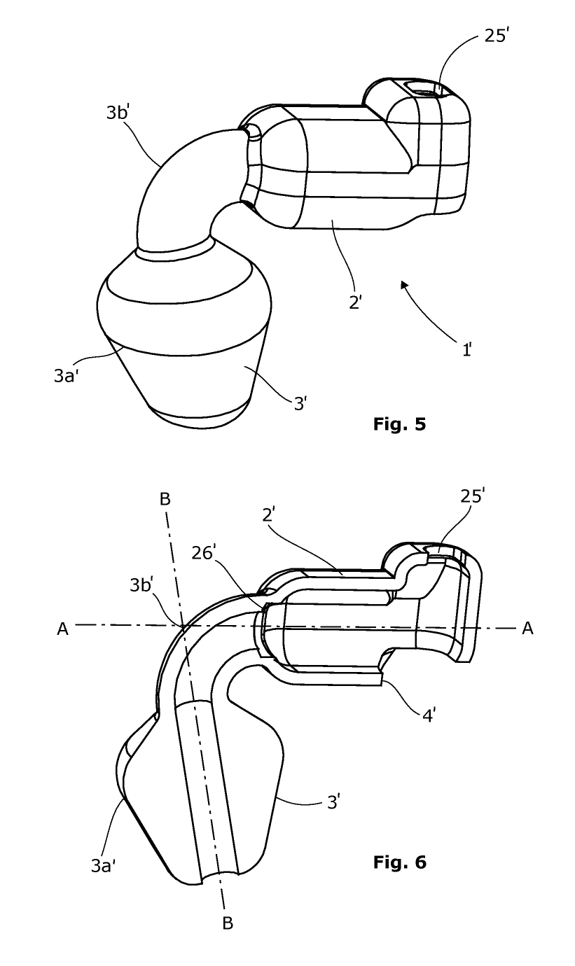

This second embodiment of the invention is shown in FIGS. 5-7, where corresponding elements have the same reference numerals, but are, as all reference numerals relating to the second embodiment, provided with primes for distinction.

FIG. 5 shows a sleeve member 1′ comprising a body 2′ and a tubular spout 3′. Like in the tubular spout 3 of FIG. 1, the wall thickness of the tubular spout 3′ varies so that the diameter at the line 3a′ is larger and generally also bi-conic. Though the terms diameter and bi-conic are used, it should, however, be noted that the cross section need not necessarily be circular, but could be oval or elliptical, to better fit into the ear canal of the user.

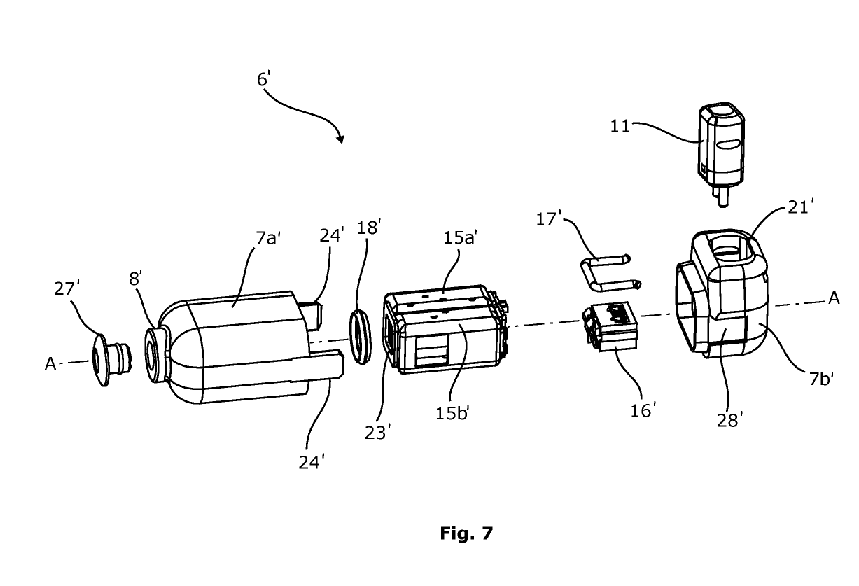

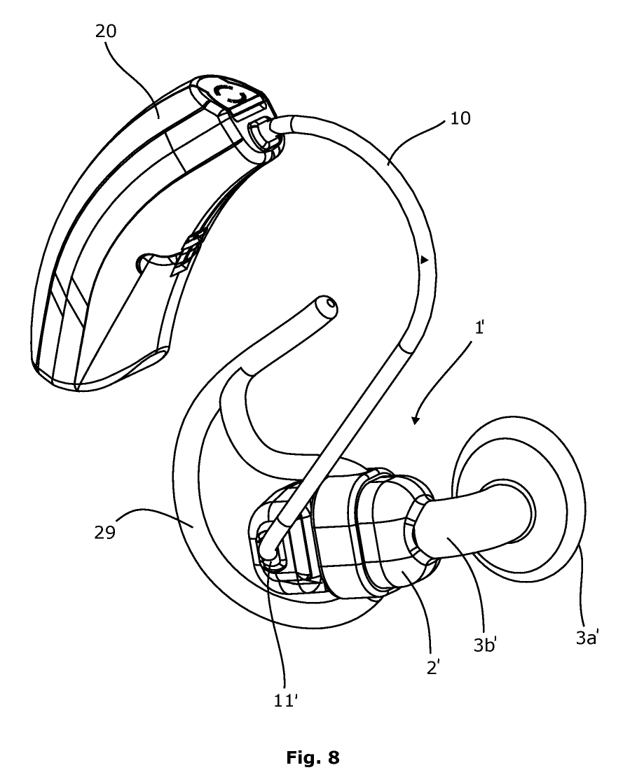

As can also be seen from FIG. 5, the tubular spout 3′ comprises a curved section constituting a flexible joint 3b′. As best seen in the cross-sectional view of FIG. 6 the flexible joint 3b′ turns the output port towards a direction B-B differing from the first direction A-A, which is the direction in which the elongated housing of the receiver module 6′ is elongated, cf. FIG. 7. The flexible joint 3b′ efficiently allows the bi-conic part of the tubular spout 3′ to be pointed in different directions when inserted in to the ear canal of a user, i.e. altering the angle between the second direction B-B and the first direction A-A, thus adapting itself to the specific angle of the ear canal, which depends on the individual anatomy of the user.

The size of the bi-conic part is somewhat larger than that of FIG. 1. The entire sleeve member 1′ is preferably made out of one and the same material. The material should be biocompatible and is preferably an elastic soft silicone material, such as silicone rubber, but the skilled person will realise that other materials could be used, e.g. fluorosilicone or a thermoplastic elastomer. Elastic in this context means that the material has a Shore A hardness of less than 90, and soft elastic material means a Shore A hardness of less than 50, e.g. in the interval of 15 to 40, preferably 25. In this respect it should be noticed, that because of these materials and the length of the flexible joint 3b′, the flexible joint 3b′ is in no way comparable to the sound guiding tube mentioned in the second paragraph of the present disclosure.

Preferably a selection of sleeves with different sizes are offered to accommodate users with different shapes and sizes of ears. For children it is estimated that a general population will be well accommodated by offering a selection with oval spouts in the sizes 6.5 by 3.7 mm, 7.0 by 4.55 mm, 7.5 by 5.5 mm, 8.0 by 5.8 mm, and 8.5 by 6.2 mm. The longer axis in the oval spouts should extend perpendicular to the axes A and B shown in FIG. 6. The soft spout permits some twisting as may be appropriate to accommodate particular users. Hereby adaptation to a larger ear canal, as may be required as a child grows, can be accommodated by exchanging the sleeve part.

Like the body 2 of the sleeve member 1 of FIG. 1, the body 2′ has three openings, as best seen in FIG. 6. The purposes of the three openings, however, differ a little between the embodiments. The first opening 4′ is for the insertion of the receiver module 6′. The receiver module itself is shown in FIG. 7, and will be described further below. The second opening 25′ is for the insertion of the plug 11 of the electrical input wire 10. The third opening 26′ is the one from which the spout 3′ extends. Having a first opening 4′ for the insertion of the receiver module 6′ and a second opening 25′ for the insertion of the plug 11 of the electrical wire 10 improves security, because the plug 11 will have to be withdrawn from the socket element 16′ of the receiver module 6′ before the receiver module 6′ itself can be removed from the sleeve member 1′. Thus, an improved security against children taking the parts apart, and e.g. swallowing them, is provided.

Moreover, in particular as regards the security aspect, this embodiment is preferred. The dimensions of the three openings, viz. the first opening 4′, the second opening 25′ and the third opening are selected so that only the second opening 25′ is large enough for insertion of the receiver module, and only for inserting it in the longitudinal direction. The two other openings, i.e. the opening 4′ for insertion of a plug 11 into the socket 21′, cf. FIG. 7 and the third opening 26′, are smaller, not allowing passage of the receiver module 6′. When the plug 11′ is inserted into the socket 21′ and locked with the spring 17′ it is effectively secured and hinders withdrawal of the receiver module 6′ through the first opening, as the conductor 10 would have to be drawn through the second opening 25′.

As can best be seen from FIG. 8 the conductor 10 has a bend close to the plug 11′, which in combination with the elongate shape of the receiver module 6′ renders this impossible or at least very difficult. Moreover even if someone, e.g. a child, succeeds in withdrawing the receiver module 6′ the through the first opening 4′ sleeve member will still not be separated from the remainder of the hearing aid, as it would be caught on the conductor 10 between the receiver module 6′ and the hearing aid housing 20, cf. FIG. 8.

As already mentioned, the third opening 26′ is so small that the receiver module 6′ cannot be withdrawn that way, in fact it is so small that not even the earwax guard 27′ can be withdrawn removed that way. Thus, even though the sleeve member 1′ is made of soft elastic material a good security against separation of the parts is provided.

As can be seen from comparison between FIGS. 4 and 7, showing the exploded views of the receiver modules 6 and 6′, respectively, the receiver modules 6 and 6′ differ in that the receiver module 6 is assembled in the lateral direction, whereas the receiver module 6′ is assembled in the longitudinal direction A-A of an elongated housing. The elongated housing thus comprises a front part 7a′ and a rear part 7b′, rather than upper and lower parts 7a, 7b. This difference is, however, not crucial for the interoperability of the sleeve members 1, 1′. Thus with the sleeve member 1, a receiver module assembled in the longitudinal direction could just as well be used, and vice versa for the sleeve member 1′. The important difference in the interoperability is that the second spout 8′ extends in the longitudinal direction to match the third opening 26′ of the sleeve member 1′, through which sound is to be emitted from the receivers 15a′, 15b′.

The second spout 8′ extends from a front part 7a′ of the elongated housing, and is provided with an earwax guard 27′ as also described (but not shown) for the first embodiment. For acoustic sealing, a sealing and/or damping member 18′ is provided between the inner wall of the front part 7a′ of the elongated housing and the combined output 23 of the receivers 15a′ and 15b′. A socket element 16′ is located between the receivers 15a′ and 15b′ and the inner wall of the rear part 7b′ of the elongated housing. The plug 11 is secured using a fastening spring 17′ for fixing it to the socket element 16′, when inserted through the opening 21′ in the rear part 7b′ of the elongated housing. For securing the front and the rear housing parts 7a′, 7b′ together, the rear housing part 7b′ has recesses 28′ in which snap acting catch members 24′ provided on the front housing part 7a′ may engage in a snap interlock.

FIG. 8 shows a hearing aid BTE housing 20 connected to a receiver module 6′. The BTE housing is adapted for being placed behind the ear and it houses microphone, processor and battery etc. as will be evident to those skilled in the art. The receiver module is not visible in FIG. 8 because it is covered by the body 2′ of a sleeve member 1′, which is part of a receiver assembly according to the second aspect of the invention. The sleeve member 1′ is held by a retaining module 29 for keeping the hearing aid in place in the ear by engaging the concha. The retaining module 29 may be a separate part fitted on the body 2′ by threading the body through a resilient loop of the retaining module. In other embodiments the retainer module may be more permanently affixed, e.g. by gluing or welding, or it may be cast integrally with at least an outer part of the body 2′.

The retaining module 29 as such does not form part of the present invention and will not be described any further. However, since the shape of the retaining module 29 is adapted to engage the concha, the skilled person will notice that even with the present embodiment, where the receiver module comprises two receivers, there is still plenty of room in the concha, and thus realise just how advantageous the present invention is. The hearing aid 20 provides the receiver module 6′ with an input signal via the electrical input wire 10 and the socket element 16′ (not visible in FIG. 8) to which the receivers 15a′, 15b′ are connected. The receivers 15a′, 15b′ convert the electrical input signal to an acoustic sound output, which by means of the spout 3′ of the sleeve member 1′ is guided into the ear canal from the output 23′ of the receivers 15a, 15b. Each receiver 15a, 15b covers a specific range of the acoustic output frequency band such as bass frequencies and treble frequencies, which improves the overall output operating frequency range of the hearing aid and provides the hearing impaired user with amplified high fidelity sound.

As to the retaining module 29 it should be noted that the construction of the sleeve contributes to the security thereof, because if the retaining module is pulled of the body 2′ of the sleeve member 1 in a direction towards the spout, it will be caught between the body and the widest part of the spout 3′ at the line 3a′, and thus cannot be separated from the overall hearing aid. On the other hand, if the retaining module is pulled of the body 2′ of the sleeve member 1 in a direction towards the conductor, it will be caught between the hearing aid housing 20 and the body, and thus cannot be separated from the overall hearing aid.

The invention should not be regarded as limited to the embodiments shown and described in the above, but several modifications and combinations may be carried out without departing from the scope of the appended claims.

We claim:

1. A sleeve member made of an elastic material adapted for mounting a receiver module of a hearing aid of the receiver-in-the-ear (RITE) type in the concha of an ear, said receiver module comprising an elongated housing having an extension in a first direction and adapted for receiving an electrical input signal, a sound output port and at least one receiver for converting said input signal to an acoustic output signal,
said sleeve member comprising a body adapted to at least partly enclose said receiver module when inserted therein, and a spout for extending said sound output port of the elongated housing into the ear, wherein
the spout extends said output port towards a second direction differing from said first direction, when said receiver module is inserted in said sleeve member.

2. The sleeve member according to claim 1, wherein said spout is adapted to fit into an ear canal meatus.

3. The sleeve member according to claim 1, wherein said sleeve member is replaceable.

4. The sleeve member according to claim 1, wherein said sleeve member comprises a silicone material.

5. The sleeve member according to claim 4, wherein said elastic material has a Shore A hardness in the interval between 15 and 40, preferably approximately 25.

6. A receiver assembly adapted for mounting a receiver module of a hearing aid of the receiver-in-the-ear (RITE) type in the concha of an ear, said receiver assembly comprising
a receiver module adapted for receiving an electrical input signal and comprising at least one receiver for converting said input signal to an acoustic output signal, said receiver module further comprising an elongated housing having an elongation in a first direction and a sound output port, and
a sleeve member made of an elastic material comprising a body adapted to at least partly enclose said receiver module when inserted therein, and a spout for extending said sound output port of the elongated housing into the ear, wherein
said spout extends said output port towards a second direction differing from said first direction, when said receiver module is inserted in said sleeve member.

7. The receiver assembly according to claim 6, wherein said spout is adapted to fit into the ear canal.

8. The receiver assembly according to claim 6, wherein said sleeve member is replaceable.

9. The receiver assembly according to claim 6, wherein said sleeve member comprises a silicone material.

10. The receiver assembly according to claim 9, wherein said elastic material has a Shore A hardness in the interval between 15 and 40, preferably approximately 25.

11. The receiver assembly according to claim 6, wherein said receiver module comprises a socket for receiving an electrical input signal, and said elongated housing has a symmetry plane in which said socket is disposed.

12. A hearing aid of the receiver-in-the-ear (RITE) type comprising
a receiver module to be mounted in the concha of an ear and adapted for receiving an electrical input signal, said receiver module comprising at least one receiver for converting said input signal to an acoustic output signal, and said receiver module further comprising an elongated housing having an elongation in a first direction,
and a sleeve member made of an elastic material and comprising a body adapted to at least partly enclose said receiver module when inserted therein, and a spout for extending said sound output port of the elongated housing into the ear, wherein
said spout extends said output port towards a second direction differing from said first direction, when said receiver module is inserted in said sleeve member.

13. The hearing aid according to claim 12, wherein said spout is tubular and adapted to fit into the ear canal.

14. The hearing aid according to claim 12, wherein said sleeve member is replaceable.

15. The hearing aid according to claim 12, wherein said sleeve member comprises a silicone material.
